(19) United States
(12) Patent Application Publication
(10) Pub. No.: US 2025/0162372 A1
(43) Pub. Date: May 22, 2025

(54) SUSPENSION SYSTEM

(71) Applicant: HL MANDO CORPORATION, Pyeongtaek (KR)

(72) Inventor: Doobyung KIM, Pyeongtaek (KR)

(21) Appl. No.: 18/648,474

(22) Filed: Apr. 29, 2024

(30) Foreign Application Priority Data
Nov. 20, 2023 (KR) 10-2023-0160650

(51) Int. Cl. B60G 17/0165; B60G 17/015; B60G 17/08

(52) U.S. Cl. CPC B60G 17/0165; B60G 17/0152; B60G 17/08; B60G 2202/24; B60G 2202/414; B60G 2202/416; B60G 2400/823; B60G 2500/112

(57) ABSTRACT

A suspension system is provided. A suspension system includes a damper including a first chamber, a second chamber, and a piston disposed between the first chamber and the second chamber, a pump configured to supply fluid to the first chamber or the second chamber, and a change valve disposed between the pump and the damper to change a discharge direction of the fluid of the pump.

### CROSS-REFERENCE TO RELATED APPLICATIONS

This application claims benefit and priority to Korean Patent Application No. 10-2023-0160650, filed on Nov. 20, 2023, with the Korean Intellectual Property Office, the disclosure of which is incorporated herein in its entirety by reference.

### TECHNICAL FIELD

An embodiment of the present disclosure relates to a suspension system, and more specifically, to a suspension system that can control a damping force of a damper by changing a discharge direction of a pump without changing a direction of the pump.

### BACKGROUND

Typically, suspension systems are installed in vehicles to improve riding comfort of drivers or passengers.

A pump installed in the suspension system rotates in one direction or the other direction, and an inlet and outlet of the pump are switched. Therefore, a discharge direction of hydraulic oil discharged from the pump changes depending on the rotation direction of the pump.

However, in this case, since the rotation direction of the pump must be controlled to change the discharge direction of the pump, there is a problem in that responsiveness is slowed when changing the discharge direction of the pump.

In addition, there is a problem that the lifespan of components inside the pump is reduced in order to control the rotation direction of the pump. Specifically, when the discharge direction of the pump suddenly changes, shock is applied to a gear installed inside the pump, causing excessive wear, reduced durability, and noise problems. In other words, when the discharge direction of the pump is repeatedly and suddenly changed to respond to the rapid responsiveness of the suspension system, there is a problem that the lifespan of the pump is reduced.

### SUMMARY

An embodiment of the present disclosure provides a suspension system with quick responsiveness to control the damping force of the damper by changing the discharge direction of the pump.

According to an embodiment of the present disclosure, there is provided a suspension system including: a damper including a first chamber, a second chamber, and a piston disposed between the first chamber and the second chamber; a pump configured to supply fluid to the first chamber or the second chamber; and a change valve disposed between the pump and the damper to change a discharge direction of the fluid of the pump.

The change valve may be supported by the pump.

The change valve may supply the fluid from the pump to the first chamber or the second chamber.

The pump may rotate in one direction.

The suspension system may further include an accumulator that stores the fluid and supplies the fluid to the first chamber or the second chamber.

The accumulator may include an adjuster configured to adjust an internal volume.

According to an embodiment of the present disclosure, there is provided a suspension system installed in a vehicle, the suspension system including: a damper including a first chamber, a second chamber, and a piston disposed between the first chamber and the second chamber; a pump configured to supply fluid to the first chamber or the second chamber; a change valve disposed between the pump and the damper to change a discharge direction of the fluid of the pump; a detector configured to detect traveling environment information in front of a vehicle; and a controller configured to selectively control the change valve according to the information detected by the detector.

When it is determined that the fluid has to be supplied to either the first chamber or the second chamber based on the information detected by the detector, the controller may control the change valve to change the discharge direction of the fluid by the pump while maintaining rotation of the pump in one direction.

The suspension system may further include an accumulator that stores the fluid and is controlled by the controller to supply the fluid to the first chamber or the second chamber.

The accumulator may include an adjuster configured to adjust an internal volume.

The controller may control the adjuster based on the information detected by the detector to supply the fluid to the first chamber or the second chamber.

According to another aspect of the present disclosure, there is provided a suspension system installed in a vehicle, the suspension system including: a first damper including a first rebound chamber, a first compression chamber, and a first piston disposed between the first rebound chamber and the first compression chamber; a second damper including a second rebound chamber, a second compression chamber, and a second piston disposed between the second rebound chamber and the second compression chamber, and spaced apart from the first damper in a width direction of the vehicle; a first pump configured to supply a fluid to the first rebound chamber or the first compression chamber; a second pump configured to supply the fluid to the second rebound chamber or the second compression chamber; a supply valve configured to supply the fluid discharged from the first pump to the second damper or supply the fluid discharged from the second pump to the first damper; a detector configured to detect traveling environment information of a vehicle; and a controller configured to selectively control the supply valve according to the information detected by the detector.

The controller may determine a risk of collision in a direction adjacent to either the first damper or the second damper, based on the information detected by the detector.

When the controller determines that a collision occurs in a direction closer to the first damper than the second damper, the controller may open the supply valve to supply the fluid discharged from the second pump to the first damper.

The controller may supply the fluid in a direction in which the first piston of the first damper extends.

The suspension system may further include a first change valve disposed between the first pump and the first damper to change the discharge direction of the fluid of the first damper, and a second change valve disposed between the second pump and the second damper to change the discharge direction of the fluid of the second damper.

The suspension system may further include a connection flow path selectively shielded by the supply valve and configured to guide movement of the fluid between the first damper and the second damper.

The supply valve may include a first supply valve disposed between one side of the connection flow path and the first pump, and a second supply valve disposed between the other side of the connection flow path and the second pump.

The suspension system may further include a first accumulator configured to store the fluid and supply the fluid to the first rebound chamber or the first compression chamber, and a second accumulator configured to store the fluid and supply the fluid to the second rebound chamber or the second compression chamber.

The controller may control a damping force by adjusting a volume inside the first accumulator or the second accumulator based on the information detected by the detector.

### Advantageous Effects

According to an embodiment of the present disclosure, the suspension system can have quick responsiveness and control damping force by changing the discharge direction of the pump by the valve.

In addition, the suspension system can reduce the collision force in case of a vehicle collision by adjusting a height of a vehicle body using the hydraulic oil discharged from the pump.

### BRIEF DESCRIPTION OF THE DRAWINGS

FIGS. 1 and 2 illustrate an operating process of a suspension system according to one embodiment of the present disclosure.

FIG. 3 illustrates a detailed configuration of an accumulator according to one embodiment of the present disclosure.

FIG. 4 is an enlarged view of a portion A of FIG. 3.

FIG. 5 illustrates a configuration for controlling a suspension system according to one embodiment of the present disclosure.

FIG. 6 illustrates a suspension system according to another embodiment of the present disclosure.

FIG. 7 illustrates a configuration for controlling a suspension system according to another embodiment of the present disclosure.

### DETAILED DESCRIPTION

Hereinafter, with reference to the attached drawings, embodiments of the present disclosure will be described in detail so that those skilled in the art can easily implement the present disclosure. The present disclosure may be implemented in many different forms and is not limited to the embodiments described herein.

Please note that the drawings are schematic and not drawn to scale. The relative dimensions and proportions of parts in the drawings are exaggerated or reduced in size for clarity and convenience in the drawings, and any dimensions are illustrative only and are not limiting. In addition, for identical structural elements or parts that appear in two or more drawings, the same reference numerals are used to indicate similar features.

The embodiments of the present disclosure specifically represent ideal embodiments of the present disclosure. As a result, various variations of the diagram are expected. Accordingly, the embodiment is not limited to the specific shape of the illustrated area and also includes changes in shape due to manufacturing, for example.

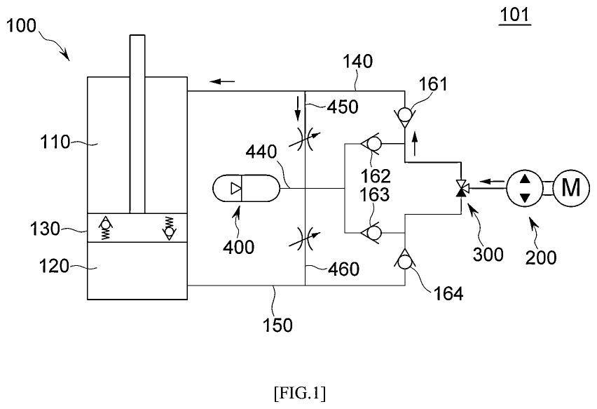

Hereinafter, with reference to FIGS. 1 to 5, a suspension system 101 according to one embodiment of the present disclosure will be described.

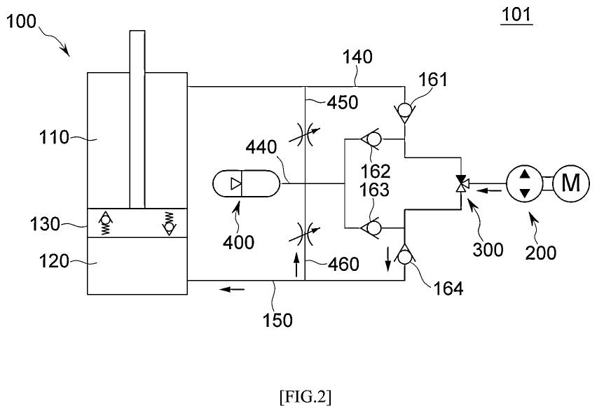

The suspension system 101 according to one embodiment of the present disclosure includes a damper 100, a pump 200, and a change valve 300, as illustrated in FIGS. 1 and 2.

The damper 100 includes a first chamber 110, a second chamber 120, and a piston 130 disposed between the first chamber 110 and the second chamber 120 inside the damper. The piston 130 performs division between the first chamber 110 and the second chamber 120, and as illustrated in FIG. 1, a piston rod connected to the piston expands and contracts to adjust ride comfort of a vehicle or a height of a vehicle body. Specifically, a pressure or volume of the first chamber 110 and the second chamber 120 is adjusted according to the movement of the piston 130.

For example, the first chamber 110 may be a rebound chamber, and the second chamber 120 may be a compression chamber.

The pump 200 may supply a fluid to the first chamber 110 or the second chamber 120. The pump 200 supplies the fluid to the first chamber 110 or second chamber 120 and moves the piston 130 to adjust the ride comfort of the vehicle or the height of the vehicle body.

The change valve 300 is placed between the pump 200 and the damper 100. Additionally, the change valve 300 changes a discharge direction of the fluid of the pump 200. Specifically, the change valve 300 may supply the fluid discharged from the pump 200 to the first chamber 110 or the second chamber 120, or supply the fluid from the damper 100 to the pump 200.

With this configuration, the suspension system 101 according to one embodiment of the present disclosure allows the change valve 300 to change the discharge direction of the fluid of the pump 200. Therefore, there is no need to change the rotation direction of the pump 200 to change the discharge direction of the pump 200 to supply fluid into the damper 100.

As a result, the suspension system 101 according to one embodiment of the present disclosure can improve the lifespan of the pump 200 and the responsiveness of the damper 100.

Additionally, the change valve 300 according to one embodiment of the present disclosure may be supported by the pump 200.

The change valve 300 is supported by the pump 200, and thus, when installing the suspension system 101, a separate space for an installation space of the change valve 300 may not be required.

Additionally, the change valve 300 is supported by the pump 200, and thus, the discharge direction of the fluid of the pump 200 can be easily changed.

For example, the change valve 300 may be installed in the pump 200 and manufactured as a single module with the pump 200.

In addition, the change valve 300 of the suspension system 101 according to one embodiment of the present disclosure may supply the fluid from the pump 200 to the first chamber 110 or the second chamber 120, or supply the fluid from the damper 100 to the pump 200.

The change valve 300 may supply the fluid from the pump 200 to the first chamber 110 or second chamber 120 of the damper 100 by opening and closing the flow path, or supply the fluid from the damper 100 to the pump 200.

For example, the change valve 300 may be a three-way valve.

Additionally, the pump 200 of the suspension system 101 according to one embodiment of the present disclosure can rotate in one direction.

When the pump 200 rotates in one direction to generate a fluid pressure, the change valve 300 is controlled to change and control the discharge direction of the fluid of the pump 200.

Specifically, conventionally, the pump changes the rotation direction and the inlet and outlet are changed, but the pump 200 rotates in one direction and the discharge direction of the fluid of the pump 200 may be changed through control of the change valve 300.

Depending on an opening state of the change valve 300, the state in which the fluid discharged from the discharge port of the pump 200 is supplied may be different.

Therefore, compared to the conventional control of fluid supply through the rotation direction of the pump, the suspension system 101 has a quick response through control of the change valve 300 and can reduce the possibility of damage to the pump.

Additionally, the suspension system 101 according to one embodiment of the present disclosure may further include an accumulator 400.

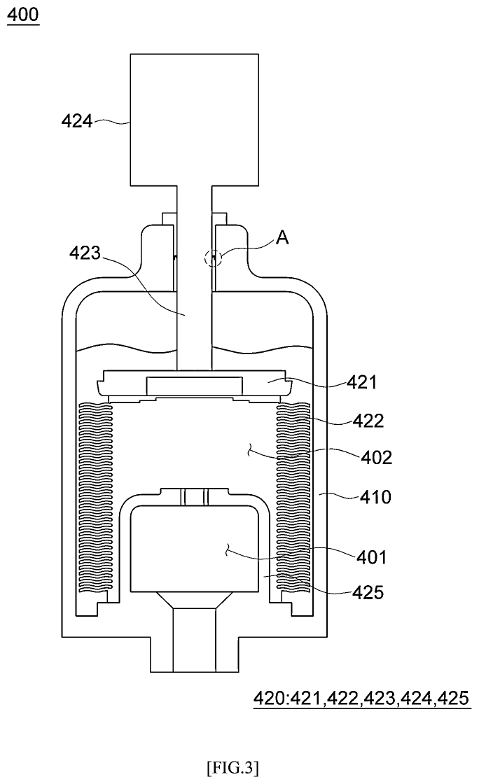

The accumulator 400 stores fluid, as illustrated in FIGS. 1 and 3. Additionally, the accumulator 400 may supply the stored fluid to the first chamber 110 or the second chamber 120.

The accumulator 400 supplies the stored fluid to the damper 100 to adjust the height of the vehicle body or ride comfort.

Accordingly, the accumulator 400 may additionally supply the fluid to the first damper 710 or the second damper 720, thereby reducing the size of the pump 200. In other words, even the pump 200 having a small capacity can exert the effect expected from the accumulator 400.

In addition, the accumulator 400 can additionally supply the fluid in addition to the hydraulic oil generated by the pump 200, thereby improving the responsiveness of the damper 100 and riding comfort.

Additionally, the accumulator 400 according to one embodiment of the present disclosure may further include an adjuster 420, as illustrated in FIG. 3.

The adjuster 420 may control an internal volume of the accumulator 400. Specifically, the adjuster 420 may include a bellows 422, a connecting member 421, a pin 423, and a motor 424.

The bellows 422 may variably respond to changes in a volume of a first area 402 of a space inside a body 410 of the accumulator 400.

Specifically, the bellows 422 may be formed of a material that can expand or contract depending on the volume change of the first area 402.

At least a portion of the pin 423 may be inserted in the body 410.

The motor 424 may provide power for movement of the pin 423.

The connecting member 421 is disposed between the pin 423 and the bellows 422 to connect the pin 423 and the bellows 422. Additionally, the connecting member 421 may vary the internal volume of the bellows 422 according to the movement of the pin 423.

As the motor 424 operates, the pin 423 is drawn in and out of the body 410, and the positions of the connecting member 421 and the bellows 422 connected to the pin 423 may be changed. Accordingly, the volume of the first area 402 inside the accumulator 400 may be changed. Accordingly, the volume in which the accumulator 400 stores the fluid can be changed by the adjuster 420.

Additionally, the accumulator 400 may further include a stopper 425 and a second area 401.

The stopper 425 may limit the volume of the first area 402 to be maintained at a minimum when the volume of the first area 402 is changed due to the movements of the connecting member 421 and the bellows 422 according to the movement of the pin 423. Specifically, the stopper 425 may have the second area 401 formed therein. That is, the second area 401 formed by the stopper 425 may communication with the first area 402.

The stopper 425 may be disposed to form a second area 401 within the body 410.

In other words, when the connecting member 421 moves, in a case where the connecting member moves in a direction adjacent to the stopper 425, the connecting member is in contact with the stopper 425, and thus, the second area 401 which is the minimum storage volume of the accumulator 400 can be maintained.

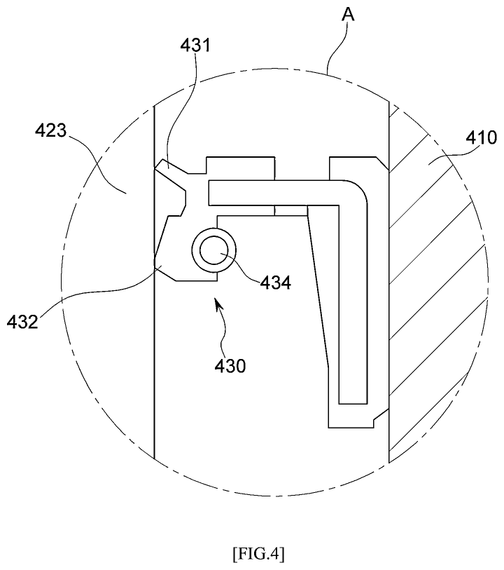

Additionally, the accumulator 400 may further include a seal 430, as illustrated in FIG. 4.

The seal 430 is disposed between the body 410 and the pin 423 to prevent fluid inside the body 410 from leaking to the outside. Additionally, the seal 430 is disposed between the moving pin 423 and the body 410 to maintain liquid-tightness or airtightness. That is, the seal 430 may be disposed along the outer circumference of the pin 423.

The seal 430 may include a first lip 431 in contact with the pin 423 and a second lip 432 in contact with the pin 423 and spaced apart from the first lip 431.

Additionally, the seal 430 may further include a garter spring 434. The garter spring 434 may press the outside of the second lip 432.

Additionally, the suspension system 101 according to one embodiment of the present disclosure may be installed in a vehicle.

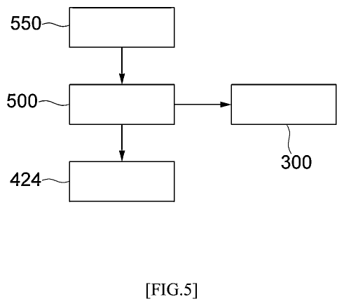

Additionally, the suspension system 101 according to one embodiment of the present disclosure may further include a detector 550 and a controller 500, as illustrated in FIG. 5.

The detector 550 can detect traveling environment information in front of the vehicle. Specifically, the detector 550 can detect information such as the road condition ahead of the vehicle and obstacles on the road.

For example, the detector 550 may detect traveling environment information in front of the vehicle using a camera.

The controller 500 may receive information detected by the detector 550. Additionally, the controller 500 may selectively control the change valve 300 based on information detected by the detector 550.

Specifically, the controller 500 may determine whether adjustment of the riding comfort is necessary based on the information detected by the detector 550. The controller 500 may determine whether it is necessary to adjust the ride comfort by adjusting the position of the piston 130 of the damper 100 based on the traveling environment information at the front of the vehicle.

In addition, when the controller 500 according to one embodiment of the present disclosure determines that fluid has to be supplied to either the first chamber 110 or the second chamber 120, the controller 500 controls the change valve 300 to change the discharge direction of the fluid of the pump 200.

When the controller 500 determines that fluid has to be supplied to either the first chamber 110 or the second chamber 120 based on the information detected by the detector 550, the controller controls the change valve 300 in a state where the one-directional rotation of the pump 200 is maintained to change the discharge direction of the fluid of the pump 200.

Specifically, when the controller 500 determines that fluid has to be supplied to the first chamber 110 based on the information detected by the detector 550, the change valve 300 controls the change valve 300 in a state where one-directional rotation of the pump 200 is maintained to supply the fluid to the first chamber 110.

Alternatively, when the controller 500 determines that fluid has to be supplied to the second chamber 120 based on the information detected by the detector 550, the change valve 300 controls the change valve 300 in a state where one-directional rotation of the pump 200 is maintained to supply the fluid to the second chamber 120.

Additionally, the controller 500 according to one embodiment of the present disclosure may control the adjuster 420 based on information detected by the detector 550.

The controller 500 may further adjust the damping force of the damper 100 based on the information detected by the detector 550. When the controller 500 determines that there is a bump and an additional obstacle according to the direction of movement of the vehicle based on the information detected by the detector 550, the controller may further adjust the damping force of the damper 100 through the adjuster 420.

Specifically, the controller 500 may supply fluid to the damper 100 by operating the pump 200 when there is a bump based on the information detected by the detector 550. At this time, when the controller 500 determines that there is an additional obstacle based on the information detected by the detector 550, the controller may control the adjuster 420 to additionally supply the fluid to the damper 100 so that the piston 130 of the damper 100 is controlled finely. The controller 500 controls the motor 424 in a direction to reduce the volume of the first area 402, and thus, the ride comfort may be controlled through fine adjustment of the piston 130.

In addition, the suspension system 101 according to one embodiment of the present disclosure may include a rebound line 140, a compression line 150, a first auxiliary line 450, a second auxiliary line 460, a main line 440, and a plurality of check valves 161, 162, 163, and 164.

The rebound line 140 may connect the first chamber 110 and the pump 200.

The compression line 150 may connect the second chamber 120 and the pump 200.

The change valve 300 can control the hydraulic oil discharged from the pump 200 to be moved to the rebound line 140 or the compression line 150.

A first check valve 161 is disposed on the rebound line 140 to prevent the hydraulic oil passing through the rebound line 140 from re-introducing into the pump 200.

A second check valve 164 is disposed on the compression line 150 to prevent the hydraulic oil passing through the compression line 150 from being re-introduced into the pump 200.

The first auxiliary line 450 may connect the accumulator 400 and the rebound line 140. The second auxiliary line 460 may connect the accumulator 400 and the compression line 150.

Specifically, the hydraulic oil may be filled with the accumulator 400 through the first and second auxiliary lines 450 and 460.

One side of the main line 440 is connected to the accumulator 400 and the other side is branched to connect the rebound line 140 and the compression line 150.

A third check valve 162 and a fourth check valve 164 are each installed on the other side of the main line 440 to prevent the fluid passing through the main line 440 from being re-introduced into the accumulator 400.

Hereinafter, as illustrated in FIGS. 1 to 5, the operating process of the suspension system 101 according to one embodiment of the present disclosure will be described.

The controller 500 receives information from the detector 550 and receives information about the surrounding environment in front of the vehicle.

When the controller 500 determines that there are no bumps, grooves, or obstacles on the road based on the information received from the detector 550, the damping force of the damper 100 can be maintained at the current level. Specifically, the controller 500 may prevent the hydraulic oil discharged from the pump 200 from being supplied to the damper 100.

In addition, when it is determined that there is an obstacle such as a bump on the road based on the information received from the detector 550, as illustrated in FIG. 1, the controller 500 may operate the change valve 300 to pressurize the second chamber 120. In this case, the pump 200 is still rotating in one direction, but the piston 130 may be moved by supplying hydraulic oil to the first chamber 110. Accordingly, the hydraulic oil may be supplied to the first chamber 110 at the timing of crossing the bump, thereby lifting the wheels of the vehicle.

Alternatively, when the controller 500 determines that there is an obstacle such as a groove on the road based on the information received from the detector 550, as illustrated in FIG. 2, the controller controls the change valve 300 so that the hydraulic oil discharged from the pump 200 is supplied to the second chamber 120.

In this case, when the controller 500 determines that there is another additional obstacle on a bump while crossing an obstacle such as the bump based on the information received from the detector 550, the controller controls the motor 424 in a direction in which the first area 402 of the accumulator 400 is reduced so that the piston 130 can be finely further moved by the fluid stored inside the accumulator 400.

Therefore, the suspension system 101 installed in a vehicle according to one embodiment of the present disclosure may adjust the damping force of the damper 100 and move the piston 130 according to information on the surrounding environment in front of the vehicle. In addition, this damping force can be adjusted by switching the change valve 300 instead of changing the rotation direction of the pump 200, ensuring quick responsiveness.

Additionally, the suspension system 101 installed in the vehicle includes the accumulator 400 whose volume can be adjusted for fine movement of the piston 130, thereby improving the riding comfort.

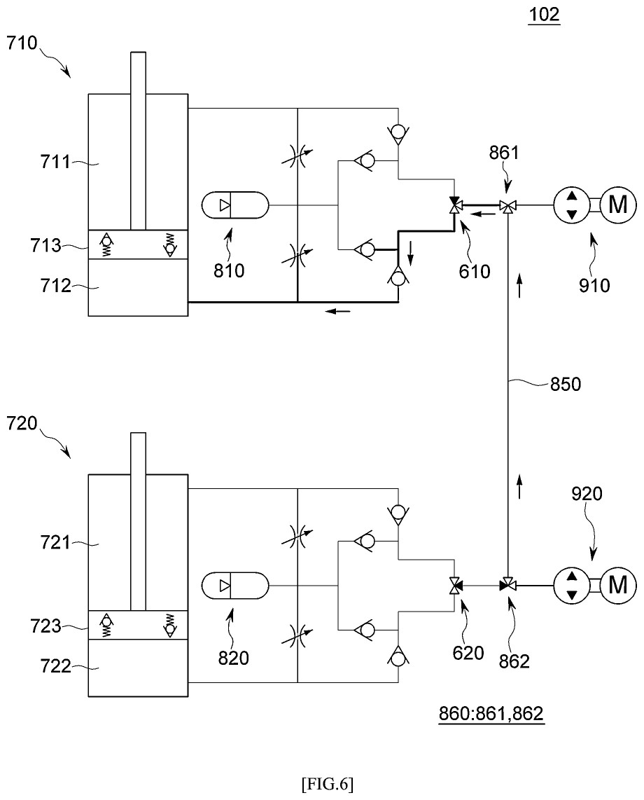

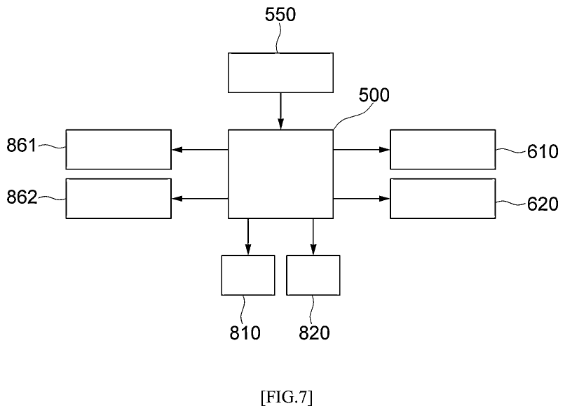

Hereinafter, with reference to FIGS. 6 and 7, a suspension system 102 installed in a vehicle according to one embodiment of the present disclosure will be described.

As illustrated in FIGS. 6 and 7, the suspension system 102 according to another embodiment of the present disclosure includes a first damper 710, a second damper 720, a first pump 910, a second pump 920, a supply valve 860, a detector 550, and a controller 500.

The first damper 710 includes a first rebound chamber 711, a first compression chamber 712, and a first piston 713. The first piston 713 is disposed between the first rebound chamber 711 and the first compression chamber 712, is moved by the pressure of the fluid, and performs division between the first rebound chamber 711 and the first compression chamber 712.

The second damper 720 includes a second rebound chamber 721, a second compression chamber 722, and a second piston 723. The second piston 723 is disposed between the second rebound chamber 721 and the second compression chamber 722, is moved by the pressure of the fluid, and performs division between the second rebound chamber 721 and the second compression chamber 722. Additionally, the second damper 720 is arranged to be spaced apart from the first damper 710 in a width direction of the vehicle.

The first pump 910 may supply fluid to the first rebound chamber 711 or the first compression chamber 712.

The second pump 920 may supply fluid to the second rebound chamber 721 or the second compression chamber 722.

The supply valve 860 may supply the fluid discharged from the first pump 910 to the second damper 720, or supply the fluid discharged from the second pump 920 to the first damper 710. Specifically, the supply valve 860 may allow fluid to selectively communicate between the first damper 710 and the second damper 720, which are spaced apart from each other.

The detector 550 detects the traveling environment information of the vehicle. The detector 550 may detect road condition information in front of the vehicle and obstacle information around the vehicle.

The controller 500 selectively controls the supply valve 860 based on information detected by the detector 550. Specifically, the controller 500 may control the supply valve 860 based on the information detected by the detector 550 to supply the fluid discharged from the first pump 910 to the second damper 720 or supply the fluid discharged from the second pump 920 to the first damper 710.

With this configuration, the suspension system 102 according to another embodiment of the present disclosure controls the supply valve 860 according to the information detected by the detector 550 to supply the fluid discharged from the first pump 910 to the second pump 910 or supply the fluid discharged from the second pump 920 to the first damper 710.

Specifically, the controller 500 may control the height of the vehicle by controlling the supply valve 860 to supply the fluid discharged from the pump to the dampers spaced apart from each other.

Additionally, the controller 500 of the suspension system 102 according to another embodiment of the present disclosure may determine a risk of collision.

The controller 500 may determine the risk of collision of the vehicle according to the information detected by the detector 550. Specifically, the controller 500 may determine the risk of collision between the vehicle and the obstacle based on the location of the obstacle and the speed of the vehicle using the traveling environment information of the vehicle.

The controller 500 may determine the risk of collision in a direction adjacent to either the first damper 710 or the second damper 720, based on the information detected by the detector 550. That is, the controller 500 may determine the risk of collision on either side of the vehicle using the information detected by the detector 550.

The controller 500 may determine whether there is the risk of collision in a direction adjacent to the first damper 710 or the risk of collision in a direction adjacent to the second damper 720 using the information detected by the detector 550.

In addition, the suspension system 102 according to another embodiment of the present disclosure may open the supply valve 860 to supply the fluid discharged from a spaced apart pump to the damper at a location where there is the risk of collision.

When the controller 500 determines that a collision occurs in a direction relatively adjacent to one of a plurality of dampers arranged spaced apart in the width direction of the vehicle, the controller opens the supply valve 860 so that the damper arranged to be adjacent to the collision occurrence receives the fluid in the pump spaced apart from the damper.

Specifically, when the controller 500 determines that the collision occurs in a direction closer to the first damper 710 than the second damper 720 based on the information detected by the detector 550, the controller opens the supply valve 860 so that the fluid discharged from the second pump 920 is supplied to the first damper 710.

In addition, in the suspension system 102 according to another embodiment of the present disclosure, when it is determined that a collision occurs in a direction adjacent to the first damper 710, the fluid may be supplied in a direction in which the first piston 713 of the first damper 710 extends.

The controller 500 may supply the fluid discharged from the second pump 920 in the direction in which the first piston 713 of the first damper 710 extends. Specifically, the controller 500 may open the supply valve 860 to supply the fluid discharged from the second pump 920 to the first compression chamber 712 of the first damper 710. Accordingly, the first piston 713 may be moved in a direction to reduce the volume by pressurizing the first rebound chamber 711 by the fluid supplied to the first compression chamber 712.

That is, the controller 500 supplies the fluid discharged from the second pump 920 to the first compression chamber 712 of the first damper 710 so that the vehicle body in the area where the first damper 710 is installed can be raised.

Accordingly, the vehicle collides with an obstacle at a high point of the vehicle body. Therefore, compared to the collision of the vehicle equipped with the conventional suspension system, even when the suspension system 101 according to one embodiment of the present disclosure is applied to a model in which a pillar between the doors located on the side of the vehicle is removed, it is safer. That is, in a vehicle in which the pillar is removed by the suspension system 102 according to one embodiment of the present disclosure, when there is the risk of collision, the vehicle body may be raised so that the area adjacent to the floor of the vehicle rather than the side collides with the obstacle.

Additionally, the suspension system 102 according to another embodiment of the present disclosure may further include a connection flow path 850.

The connection flow path 850 may connect the first pump 910 and the second pump 920. Additionally, the connection flow path 850 may guide the movement of fluid between the first damper 710 and the second damper 720. Moreover, the supply valve 860 may control opening and closing of the connection flow path 850. Specifically, the connection flow path 850 may be opened and closed by the supply valve 860 controlled by the controller 500.

In other words, the connection flow path (850) may guide the fluid in the first pump 910 to flow into the second damper 720, or guide the fluid in the second pump 920 to flow into the first damper 710.

Additionally, the supply valve 860 of the suspension system 102 according to another embodiment of the present disclosure may include a first supply valve 861 and a second supply valve 862.

The first supply valve 861 may be disposed between one side of the connection flow path 850 and the first pump 910. Additionally, the first supply valve 861 may selectively control the movement of fluid in the first pump 910 or the second pump 920 to the first damper 710.

The second supply valve 862 may be disposed between the other side of the connection flow path 850 and the second pump 920. Additionally, the second supply valve 862 can selectively control the movement in fluid from the first pump 910 or the second pump 920 to the second damper 720.

Moreover, the first supply valve 861 and the second supply valve 862 may be controlled by the controller 500. Specifically, the first supply valve 861 and the second supply valve 862 may be three-way valves.

Additionally, the suspension system 102 according to another embodiment of the present disclosure may further include a first change valve 610 and a second change valve 620.

The first change valve 610 is disposed between the first pump 910 and the first damper 710 and may change the discharge direction of the fluid in the first damper 710. Additionally, the first change valve 610 may be controlled by the controller 500. Specifically, the first change valve 610 allows the fluid discharged from the first pump 910 to flow into the first rebound chamber 711 or the first compression chamber 712, or the fluid introduced into the first damper 710 to flow into the first pump 910.

The second change valve 620 is disposed between the second pump 920 and the second damper 720 and may change the discharge direction of the fluid of the second damper 720. Additionally, the first change valve 610 may be controlled by the controller 500. Specifically, the first change valve 610 allows the fluid discharged from the first pump 910 to flow into the second rebound chamber 721 or the second compression chamber 722, or the fluid introduced into the second damper 720 to flow into the second pump 920.

Specifically, the controller 500 may control one or more of the first change valve 610 or the second change valve 620 according to road condition information in front of the vehicle according to information from the detector 550.

Additionally, the suspension system 102 according to another embodiment of the present disclosure may further include a first accumulator 810 and a second accumulator 820.

The first accumulator 810 can store fluid therein. Additionally, the first accumulator 810 may supply fluid to the first rebound chamber 711 or the first compression chamber 712.

The second accumulator 820 can store fluid therein. Additionally, the second accumulator 820 may supply fluid to the second rebound chamber 721 or the second compression chamber 722.

Additionally, the first accumulator 810 and the second accumulator 820 may include the same adjuster 420 as the accumulator 400 described above. Specifically, the internal volumes of the first accumulator 810 and the second accumulator 820 may be controlled by the controller 500.

Additionally, the first damper 710 and the second damper 720 may include a hydraulic line and a check valve included in the damper 100 described above.

Additionally, the controller 500 of the suspension system 102 according to another embodiment of the present disclosure may control the damping force by adjusting the internal volume of the first accumulator 810 or the second accumulator 820.

The controller 500 may control the damping force by finely adjusting the pistons of the dampers 710 and 720 by adjusting the volume inside the first accumulator 810 or the second accumulator 820 based on the information detected by the detector 550. Specifically, when there is an additional obstacle in the bump among the information detected by the detector 550, the controller 500 adjusts the volume inside the first accumulator 810 or the second accumulator 820, and thus, it is possible to improve the riding comfort through the fine adjustment of the piston.

Hereinafter, the operation process of the suspension system 102 according to another embodiment of the present disclosure will be described with reference to FIGS. 6 and 7.

The detector 550 detects the traveling environment information of the vehicle and the information to the controller 500. The controller 500 determines whether there is the risk of collision of the vehicle based on the information detected by the detector 550.

The controller 500 determines whether there is the risk of collision in a direction adjacent to either the first damper 710 or the second damper 720 based on a pre-stored collision risk determination reference.

As illustrated in FIG. 6, when it is determined that there is the risk of collision in a direction adjacent to the first damper 710, the controller 500 opens the second supply valve 862 so that the fluid discharged from the second pump 920 is guided through the connection flow path 850. In other words, the controller 500 may guide the fluid discharged from the second pump 920 to move to the connection flow path 850 so that the fluid is not supplied to the second damper 720 but to the first damper 710.

Additionally, the controller 500 opens the first supply valve 861 to guide the fluid moved through the connection flow path 850 to be supplied toward the first damper 710. Additionally, the controller 500 may control the first change valve 610 so that the fluid introduced through the connection flow path 850 is supplied to the first compression chamber 712.

Specifically, the controller 500 causes the fluid moved through the connection flow path 850 to expand the first piston 713 of the first damper 710. The controller 500 supplies the fluid moved through the connection flow path 850 to the first compression chamber 712. In this case, the first piston 713 may be moved in a direction in which the volume of the first rebound chamber 711 is reduced and may be moved in a direction in which the vehicle body is raised.

Accordingly, the controller 500 may transmit the hydraulic pressure produced by the second pump 920 to the first damper 710, enabling a quick response and increasing the height of the vehicle body. Accordingly, the suspension system 102 can reduce collision force in the event of collision with an obstacle or collision with the side of vehicle.

Alternatively, when the controller 500 detects that there is the risk of collision on the side adjacent to the second damper 720, the controller controls the first supply valve 861, the second supply valve 862, and the second change valve 620 so that the vehicle body in the area where the damper 720 is positioned is raised.

Additionally, the controller 500 may receive road condition information in front of the vehicle based on information detected by the detector 550 and determine whether there is an obstacle.

When the controller 500 determines that there is an obstacle such as a speed bump on the road in front of the travel direction of the vehicle, the controller 500 may adjust the damping force of the first damper 710 or the second damper 720.

When there is a speed bump in front of the travel direction of the vehicle, the controller 500 may operate the first pump 910 and the second pump 920, and may control the first supply valve 861, the second supply valve 862, the first change valve 610, and the second change valve 620 so that the fluid discharged from the first pump 910 is supplied to the first rebound chamber 711 and the fluid discharged from the second pump 920 is supplied to the second rebound chamber 721. In this case, the wheels connected to the first damper 710 and the second damper 720 are lifted to reduce the impact caused by the speed bump.

That is, the controller 500 can improve the riding comfort by quickly changing the supply direction of the fluid discharged from the pumps 910 and 920 through the control of the first and second supply valves 861 and 862 when the vehicle crosses a bump.

In this case, the controller 500 may perform control so that the volumes of the first accumulator 810 and the second accumulator 820 are reduced when there is an additional obstacle on the bump based on the information detected by the detector 550.

That is, the controller 500 may perform control so that the fluid stored in the first accumulator 810 is supplied to the first rebound chamber 711 and the fluid stored in the second accumulator 820 is supplied to the second rebound chamber 721. Therefore, the controller 500 can improve the riding comfort by finely moving the pistons 713 and 723 of the dampers 710 and 720 by the first and second accumulators 810 and 820.

Alternatively, when there is a porthole or groove on the road in front of the vehicle, the controller 500 may control the first change valve 610 and the second change valve 620 so that the fluid discharged from the first pump 910 is supplied to the first damper 710 or the fluid discharged from the second pump 920 is supplied to the second damper 720 and the wheel connected to the first damper 710 or second damper 720 is lowered to improve the riding comfort.

The controller 500 may control the opening directions of the first supply valve 861 and the second supply valve 862 so that the hydraulic oil easily moves to the rebound chambers 711 and 721 or compression chambers 712 and 722 of the dampers 710 and 720.

With this configuration, according to the suspension system 102 of another embodiment of the present disclosure, when there is a risk of collision, the height of the vehicle body connected to the side of the vehicle having high risk can be increased to the dampers 710 and 720 to reduce the shock to passengers or drivers in the event of a side collision.

Although embodiments of the present disclosure have been described above with reference to the attached drawings, those skilled in the art will understand that the present disclosure can be implemented in other specific forms without changing its technical idea or essential features.

Therefore, the embodiments described above should be understood in all respects as illustrative and not restrictive, and the scope of the present disclosure is indicated by claims described later in the detailed description, and the meaning and scope of the patent claims and all changes or modified forms derived from the equivalent concept should be construed as being included in the scope of the present disclosure.

[Detailed Description of Main Elements]

| | |
|---|---|
| 100: damper | 101, 102: suspension system |
| 110: first chamber | 120: second chamber |
| 130: piston | 200: pump |
| 300: change valve | 400: accumulator |
| 500: controller | 550: detector |
| 710: first chamber | 711: first rebound chamber |
| 712: first compression chamber | 713: first piston |
| 720: second chamber | 721: second rebound chamber |
| 722: second compression chamber | 723: second piston |
| 710: first chamber | 711: first rebound chamber |
| 610: first change valve | 620: second change valve |
| 810: first accumulator | 820: second accumulator |
| 860: supply valve | 861: first supply valve |
| 862: second supply valve | 850: connection flow path |
| 910: first pump | 920: second pump |

What is claimed is:

1. A suspension system comprising:
a damper including a first chamber, a second chamber, and a piston disposed between the first chamber and the second chamber;
a pump configured to supply fluid to the first chamber or the second chamber; and
a change valve disposed between the pump and the damper to change a discharge direction of the fluid of the pump.

2. The suspension system of claim 1, wherein the change valve is supported by the pump.

3. The suspension system of claim 1, wherein the change valve supplies the fluid from the pump to the first chamber or the second chamber.

4. The suspension system of claim 1, wherein the pump rotates in one direction.

5. The suspension system of claim 1, further comprising an accumulator that stores the fluid and supplies the fluid to the first chamber or the second chamber.

6. The suspension system of claim 5, wherein the accumulator includes an adjuster configured to adjust an internal volume.

7. A suspension system installed in a vehicle, the suspension system comprising:
a damper including a first chamber, a second chamber, and a piston disposed between the first chamber and the second chamber;
a pump configured to supply fluid to the first chamber or the second chamber;
a change valve disposed between the pump and the damper to change a discharge direction of the fluid of the pump;
a detector configured to detect traveling environment information in front of a vehicle; and
a controller configured to selectively control the change valve according to the information detected by the detector.

8. The suspension system of claim 7, wherein when it is determined that the fluid has to be supplied to either the first chamber or the second chamber based on the information detected by the detector, the controller controls the change valve to change the discharge direction of the fluid by the pump while maintaining rotation of the pump in one direction.

9. The suspension system of claim 8, further comprising an accumulator that stores the fluid and is controlled by the controller to supply the fluid to the first chamber or the second chamber.

10. The suspension system of claim 9, wherein the accumulator includes an adjuster configured to adjust an internal volume.

11. The suspension system of claim 10, wherein the controller controls the adjuster based on the information detected by the detector to supply the fluid to the first chamber or the second chamber.

12. A suspension system installed in a vehicle, the suspension system comprising:
a first damper including a first rebound chamber, a first compression chamber, and a first piston disposed between the first rebound chamber and the first compression chamber;
a second damper including a second rebound chamber, a second compression chamber, and a second piston disposed between the second rebound chamber and the second compression chamber, and spaced apart from the first damper in a width direction of the vehicle;
a first pump configured to supply a fluid to the first rebound chamber or the first compression chamber;
a second pump configured to supply the fluid to the second rebound chamber or the second compression chamber;
a supply valve configured to supply the fluid discharged from the first pump to the second damper or supply the fluid discharged from the second pump to the first damper;
a detector configured to detect traveling environment information of a vehicle; and
a controller configured to selectively control the supply valve according to the information detected by the detector.

13. The suspension system of claim 12, wherein the controller determines a risk of collision in a direction adjacent to either the first damper or the second damper, based on the information detected by the detector.

14. The suspension system of claim 13, wherein when the controller determines that a collision occurs in a direction closer to the first damper than the second damper, the controller opens the supply valve to supply the fluid discharged from the second pump to the first damper.

15. The suspension system of claim 14, wherein the controller supplies the fluid in a direction in which the first piston of the first damper extends.

16. The suspension system of claim 14, further comprising:
a first change valve disposed between the first pump and the first damper to change the discharge direction of the fluid of the first damper; and
a second change valve disposed between the second pump and the second damper to change the discharge direction of the fluid of the second damper.

17. The suspension system of claim 12, further comprising a connection flow path selectively shielded by the supply valve and configured to guide movement of the fluid between the first damper and the second damper.

18. The suspension system of claim 17, wherein the supply valve includes
a first supply valve disposed between one side of the connection flow path and the first pump, and
a second supply valve disposed between the other side of the connection flow path and the second pump.

19. The suspension system of claim 12, further comprising:
a first accumulator configured to store the fluid and supply the fluid to the first rebound chamber or the first compression chamber; and
a second accumulator configured to store the fluid and supply the fluid to the second rebound chamber or the second compression chamber.

20. The suspension system of claim 19, wherein the controller controls a damping force by adjusting a volume inside the first accumulator or the second accumulator based on the information detected by the detector.
